(19) United States
(12) Patent Application Publication
(10) Pub. No.: US 2019/0137851 A1
(43) Pub. Date: May 9, 2019

(54) CAMERA SLIDER WITH FLYWHEEL AND RAILS HAVING INDEXING SURFACES

(71) Applicant: Cinevate Ltd., Thunder Bay (CA)

(72) Inventors: Dennis Wood, Thunder Bay (CA); Tyler J. F. Bragnalo, Thunder Bay (CA)

(21) Appl. No.: 16/059,660

(22) Filed: Aug. 9, 2018

Related U.S. Application Data
(60) Provisional application No. 62/542,883, filed on Aug. 9, 2017.

(51) Int. Cl. G03B 17/56; F16M 11/04; F16M 11/22; F16D 63/00

(52) U.S. Cl. CPC G03B 17/561; F16D 63/002; F16M 11/22; F16M 11/045

(57) ABSTRACT

A camera slider assembly for supporting a camera thereon including a frame with a pair of rails and a carriage body that rolls longitudinally along the rails upon which a camera can be supported. A flywheel of conductive is supported on the frame and operatively connected to the carriage body for rotation about a flywheel axis responsive to displacement of the carriage body along the rails. A magnet movable on the frame relative to the flywheel acts as an eddy current brake to apply a controllable drag force to the flywheel rotation. The rails of the frame are indexed relative to one another using cross members having indexing surfaces, and clamping fasteners cooperating with ramped surfaces to urge the rails against the corresponding indexing surfaces as the clamping fasteners tighten the rails against the ramped surfaces.

This application claims the benefit under 35 U.S.C. 119(e) of U.S. provisional application Ser. No. 62/542,883, filed Aug. 9, 2017.

### FIELD OF THE INVENTION

The present invention relates to a camera slider of the type including a frame with rails and a carriage body which supports a camera thereon for sliding movement along the rails, and more particularly the present invention relates to a camera slider having a flywheel which is supported for rotation relative to the rails such that the flywheel rotates responsive to the longitudinal displacement of the carriage body along the rails.

### BACKGROUND

When filming with a video camera, a common method of capturing video involves displacing the camera along one or more rails using a camera slider. Typical camera slider configurations comprise a pair of rails and a carriage body that rolls along the rails upon which the camera is supported. To ensure a smooth movement of the camera along the rails, a flywheel is sometimes operatively connected to the slider.

Examples of various commercially available sliders with flywheels include i) the Axler Pro Camera Slider with Flywheel available by Gradus Group LLC, ii) the Benro MoveOver Dual Carbon Rail Slider with Flywheel available by Benro Precision Machinery (Zhongshan) Co, Ltd., and iii) the Konova Nitsan Fly Wheel available by Konova of South Korea. In each instance in the prior art, the flywheel rotates about a flywheel axis which is fixed relative to the rails at one end of the rails. Attempts to brake the flywheel using friction brakes can result in a shuddering motion which has negative effects on the images captures by the camera on the slider.

Furthermore, smooth movement of the slider along the rails requires the rails to be manufactured with a very small tolerance in dimension and shape of the rails as the variation in rail size or shape will affect spacing and orientation between running surfaces upon which the carriage body is supported for longitudinal displacement along the rails. Manufacturing rails with desired tolerances to ensure smooth movement of the carriage body along the rails can also be difficult and costly.

### SUMMARY OF THE INVENTION

According to one aspect of the present invention there is provided a camera slider assembly for supporting a camera thereon, the assembly comprising:
a frame including at least one rail extending in a longitudinal direction;
a carriage body supported on said at least one rail for longitudinal movement along the rail in the longitudinal direction;
a camera mount supported on the carriage body for supporting the camera thereon for movement with the carriage body in the longitudinal direction relative to the frame;
a flywheel supported on the frame and rotatable relative to the frame about a flywheel axis, the flywheel being formed of a conductive material;
a drive system operatively connected between the carriage body and the flywheel so as to drive rotation of the flywheel responsive to the longitudinal movement of the carriage body relative to the frame in the longitudinal direction; and
a magnet supported on the frame and positionable in proximity to the flywheel so as to induce an eddy current the conductive material of the flywheel imposing a drag force from the magnet opposing the motion of the flywheel;
the magnet being movable in distance relative to the flywheel so as to vary the drag force.

The use of eddy current brakes provides a smooth braking force which does not introduce any shudder or vibration to the movement of the slider along the rails as compared to prior art attempts to brake a slider using friction.

Preferably the magnet is movable to a non-braking position in which the drag force is negligible.

The flywheel is preferably rotatably supported at a fixed location on the frame and the magnet is movable relative to the fixed location of the flywheel on the frame.

The magnet may be movable relative to the flywheel along an adjustment axis oriented parallel to the flywheel axis. In this instance, a screw may be provided along the adjustment axis which supports the magnet on the frame such that rotation of the screw about the adjustment axis displaces the magnet relative to the flywheel along the adjustment axis.

When the frame comprises two rails and a plurality of cross members connected between the two rails to support the rails parallel and spaced apart from one another, the flywheel and the magnet are preferably supported on one of the cross members.

According to a second aspect of the present invention, there is provided a camera slider assembly for supporting a camera thereon, the assembly comprising:
a frame comprising two rails supported parallel and spaced apart from one another to extend in a longitudinal direction of the frame and a cross member connected between the two rails at each one of a plurality of coupling locations at longitudinally spaced positions along the rails;
a carriage body supported on the frame and being movable along the two rails in the longitudinal direction;
a camera mount supported on the carriage body and adapted to support the camera thereon for movement with the carriage body in the longitudinal direction relative to the frame;
each cross member comprising:
   two indexing surfaces oriented transversely to a lateral plane containing the two rails in parallel abutment with corresponding indexing surfaces on the two rails respectively;
   two auxiliary surfaces adjacent to and oriented transversely to the two indexing surfaces on the cross member respectively in abutment with corresponding auxiliary surfaces on the two rails; and
   two clamping fasteners operatively connected between the cross member and each of the rails respectively, such that each clamping fastener is arranged to urge both a respective one of the indexing surfaces of the cross member and a respective one of the auxiliary surfaces of the cross member against the corresponding indexing surface and auxiliary surface of the respective rail.

The use of indexing surfaces and transverse auxiliary surfaces at the connection of each cross member to each rail permit two rails with minor variations in size and/or shape to be accurately indexed relative to one another using a single fastener at each connection. The spacing between running surfaces on the rails upon which the carriage body is supported for longitudinal displacement along the rails can thus be accurately controlled without relying on rails which are manufactured at high cost with a very small tolerance.

Preferably the indexing surfaces of the two rails are oriented parallel to one another and perpendicularly to the lateral plane containing the two rails.

Each rail may further comprise a channel extending longitudinally along the rail so as to define an internal shoulder within the channel in which each clamping fastener is operatively connected to provide a clamping force between the internal shoulder of the respective rail and an opposing surface on the respective cross member.

The frame preferably comprises two cross members at each coupling location which are coupled to each rail at diametrically opposed top and bottom sides of the rail. In this instance, the indexing surfaces of each rail may comprise an upper indexing surface engaged by one of the cross members at a top side of the rail and a lower indexing surface engaged by one of the cross members at a bottom side of the rail. Preferably the upper and lower indexing surfaces lie in a common plane at an inner side of the rail facing inwardly towards the other rail and a running surface is further provided at an inner side of each rail between the upper and lower indexing surfaces upon which the carriage body is supported for movement along the rails.

Each auxiliary surface of each cross member may be oriented non-perpendicularly at an acute interior angle relative to the respective indexing surface.

The auxiliary surfaces on the rails are preferably oriented in parallel abutment with respective ones of the auxiliary surfaces on the cross members.

Each clamping fastener may be oriented parallel to the indexing surfaces.

The clamping fasteners may be the only fasteners securing each cross member to the rails, in which the clamping fasteners are all oriented perpendicularly to the lateral plane containing the two rails.

### BRIEF DESCRIPTION OF THE DRAWINGS

Some embodiments of the invention will now be described in conjunction with the accompanying drawings in which:

FIG. 1 is a perspective view showing a top side of the camera slider assembly according to a first embodiment;

FIG. 2 is a perspective view showing a bottom side of the camera slider assembly according to the first embodiment of FIG. 1;

FIG. 3 is a sectional view along the line 3-3 of FIG. 2;

FIG. 4 is a sectional view along the line 4-4 of FIG. 2;

FIG. 5 is a sectional view along the line 5-5 of FIG. 1;

FIG. 6 is a perspective view of the cross members and an end cap at one end of the rails, shown removed from the rails according to the first embodiment of FIG. 1;

FIG. 7 is a top plan view of the camera slider assembly according to the first embodiment of FIG. 1; and

FIG. 8 is a sectional view along the line 5-5 of FIG. 1 according to a second embodiment of the camera slider assembly.

In the drawings like characters of reference indicate corresponding parts in the different figures.

### DETAILED DESCRIPTION

Referring to the accompanying Figures, there is illustrated a camera slider assembly generally indicated by reference numeral 10. The camera slider assembly is particularly suited for supporting a camera 12 thereon which is capable of capturing video. The camera slider assembly 10 is capable of being supported on various supporting surfaces.

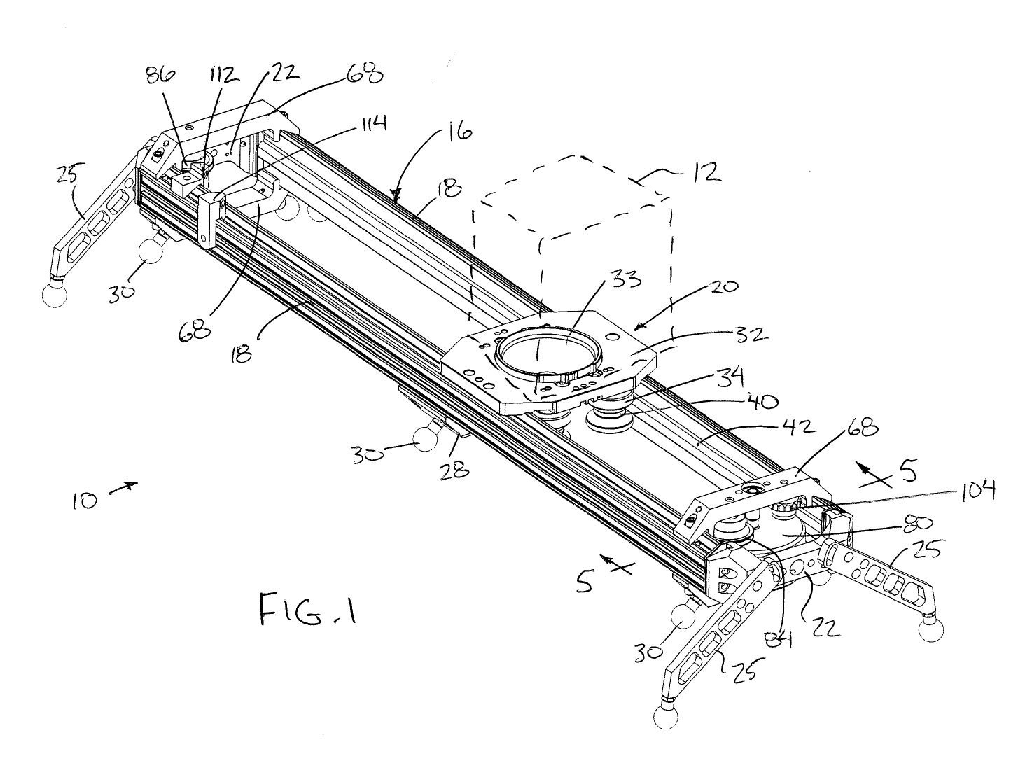

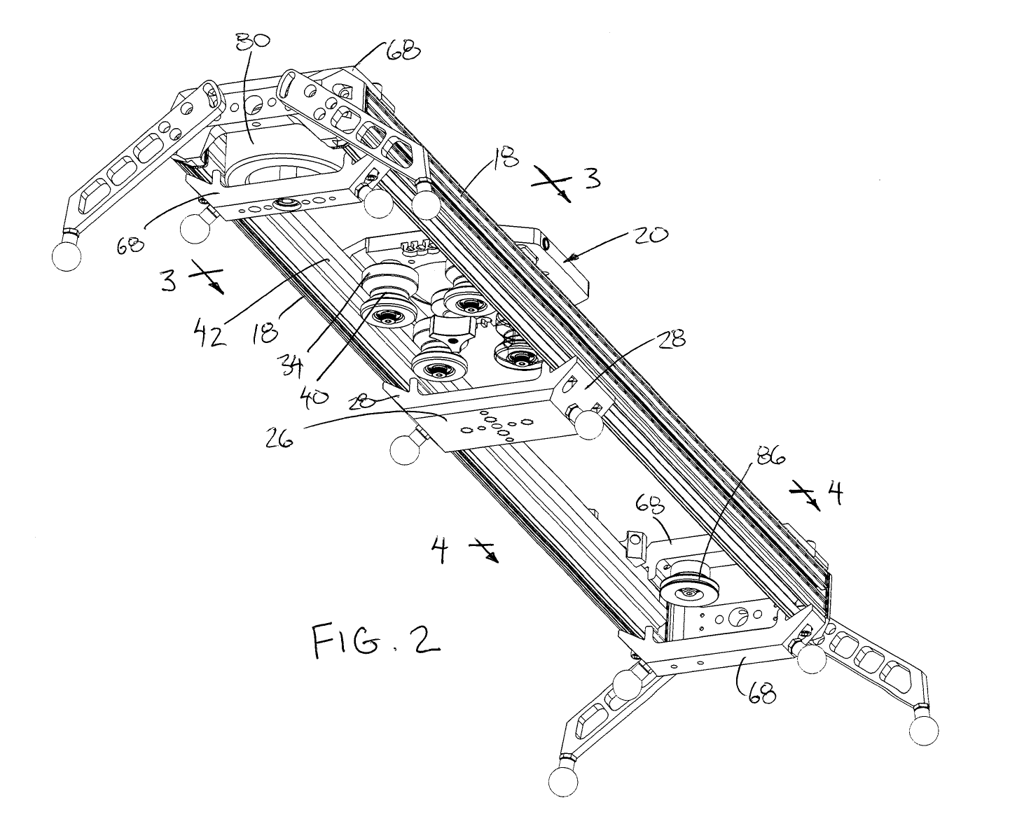

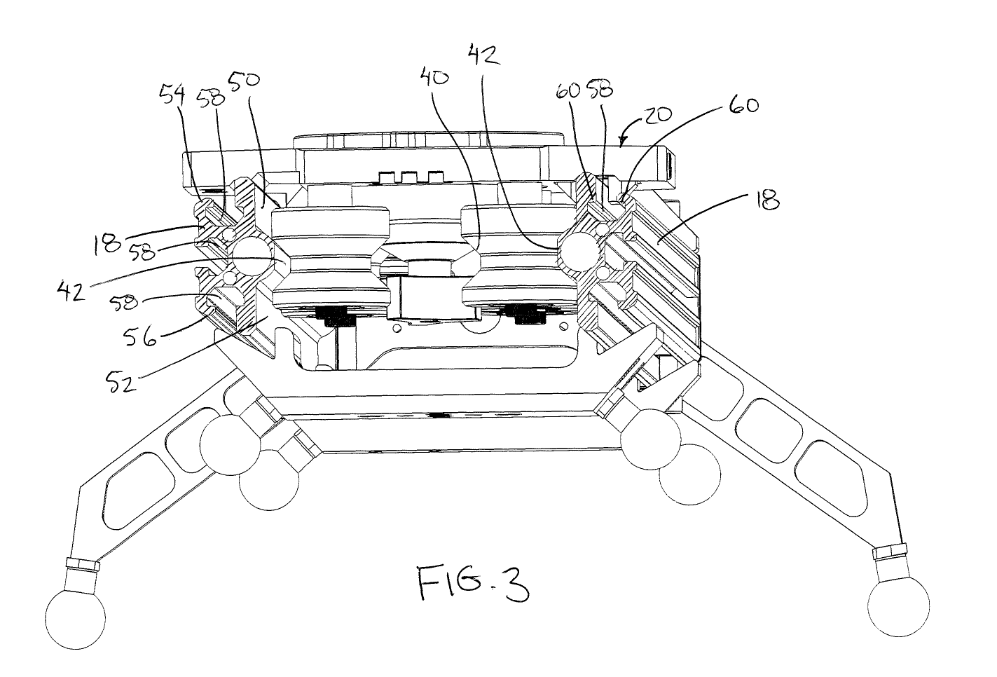

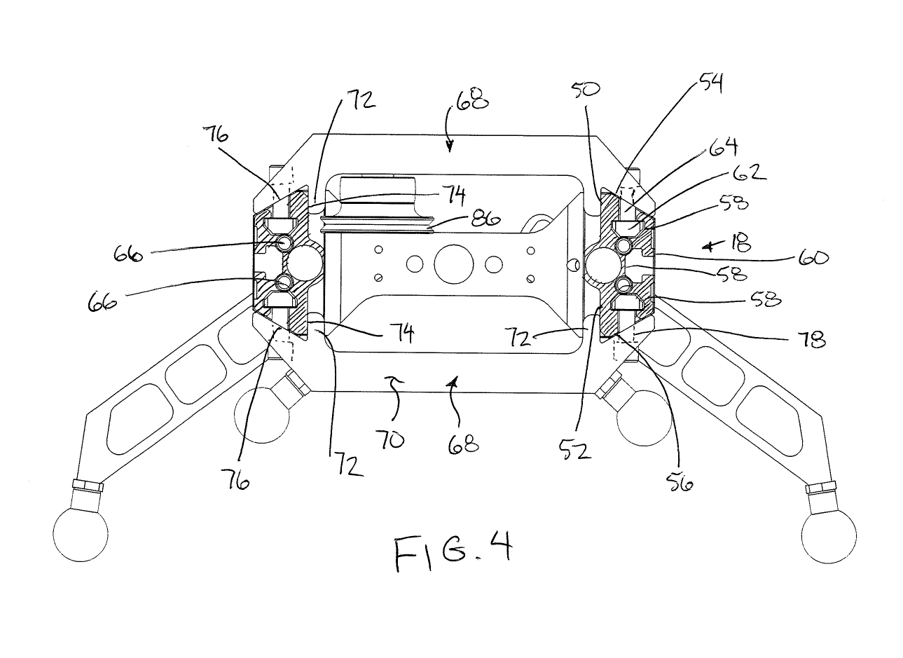

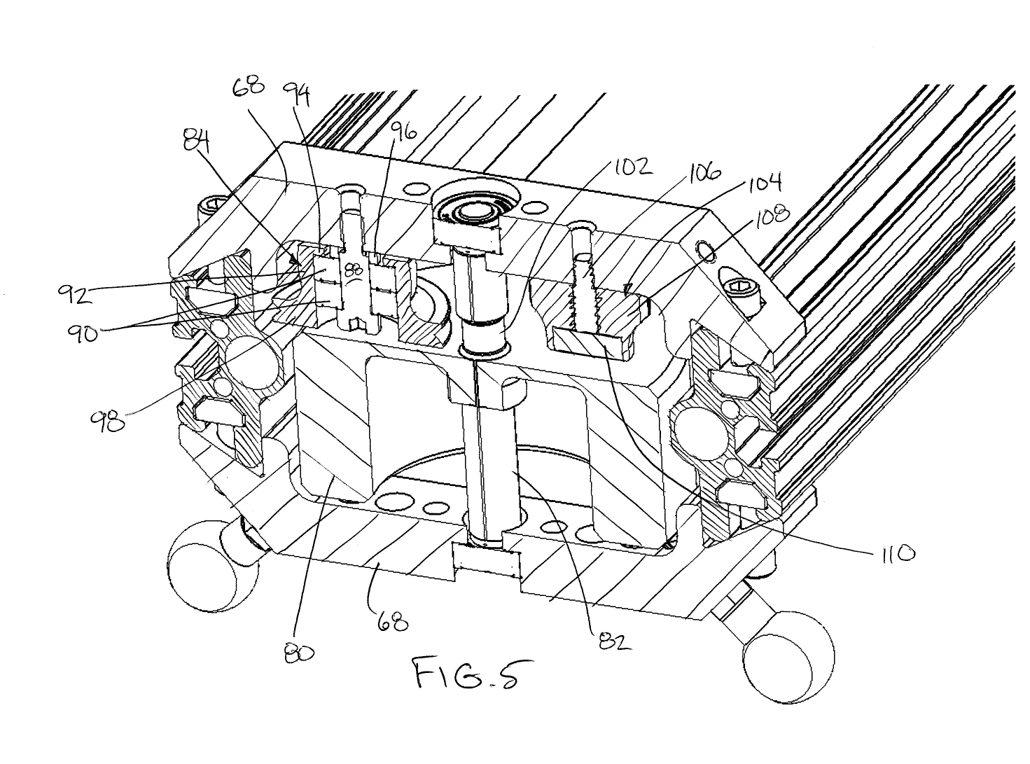

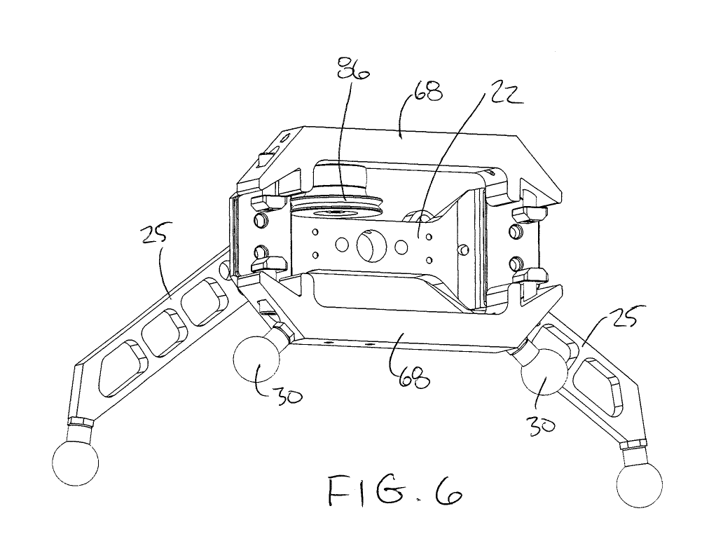

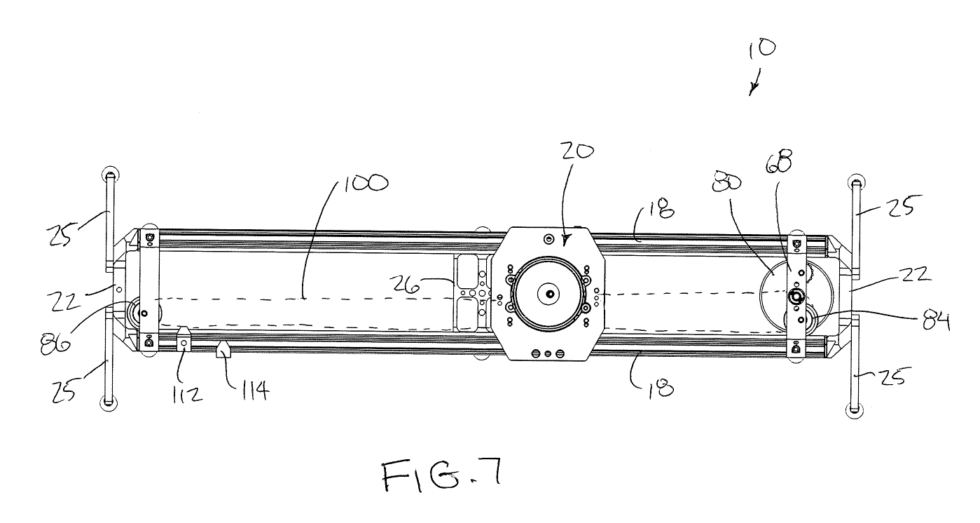

Although various embodiments are shown in the accompanying figures, the first embodiment of FIGS. 1 through 7 will first be described.

The camera slider assembly 10 generally includes a frame 16 which includes two parallel and spaced apart rails 18 which extend in a longitudinal direction, and a carriage body 20 supported on the rails 18 for movement relative to the frame in the longitudinal direction of the rails.

The rails 18 of the frame each comprises an extruded member, the details of which are described in further detail below.

The two rails 18 are capped at longitudinally opposed ends of the frame by two end portions 22 of the frame. Each end portion 22 extends in a lateral direction between respective ends of the rails that one end of the frame.

A pair of adjustable legs 25 are also pivotally connected to each end portion 22 having respective feet thereon for engaging a supporting surface at various heights relative to the rails if desired.

The frame further includes a tripod mounting plate 26 coupled between the two rails at a location spaced below the rails at a central location in the longitudinal direction between the two end portions 22. The tripod mounting plate 26 is a generally flat rectangular plate which is parallel to a common lateral plane containing the two rails. The mounting plate 26 includes a plurality of mounting apertures therein to form a suitable connection to the mounting head 14 of a camera supporting structure therebelow using suitable fasteners.

Two side portions 28 of the frame extend upward from laterally opposing sides of the tripod mounting plate for connection to respective ones of the two rails 18 above the plate 26. An adjustable foot 30 is mounted on each side portion 28 to protrude below the bottom side of the tripod the mounting plate 26. Each foot 30 is identical in configuration to the feet of the legs 25, but are mounted using a threaded shaft connected to the mounting plate 26 so as to be adjustable in height. The side portions 28 are also described in further detail below.

The carriage body 20 generally includes an upper mounting plate 32 in the form of a flat rectangular plate including a plurality of mounting apertures formed therein to define a camera mount upon which a body of a camera 12 can be secured in fixed relation for example. A central semi-spherical bowl-shaped recess 33 is also provided centrally within the upper mounting plate 32

The carriage body 20 is supported for rolling movement along the rails by a set of four carriage wheels 34. Each carriage wheel is rotatable about a respective wheel axis which is perpendicular to the upper mounting plate 32. The four wheel axes are oriented in a rectangular configuration relative to one another such that two carriage wheels are arranged for rolling movement along an inner side surface of each of the two rails 18.

Each carriage wheel 34 is supported by annular bearings 36 on a respective mounting post 38. The mounting post 38 is fixed at an upper end to the upper mounting plate and supports a pair of annular bearings at axially spaced positions thereon. Each carriage wheel comprises a sleeve having a hollow cavity therein receiving the annular bearings in a manner which rotatably supports the carriage wheel on the mounting post 38. The outer periphery of each wheel includes a concave groove 40 on the outer surface thereof which extends circumferentially about the wheel for mating with the semicircular profile of a corresponding running surface 42 at the inner side of a respective rail upon which the carriage wheel is engaged for rolling movement therealong.

Each of the rails 18 includes an upper indexing surface 50 and a lower indexing surface 52 which are coplanar with one another at an inner side of the rail facing towards the other rail. The upper and lower indexing surfaces are adjacent the respective top and bottom of the rail. The indexing surfaces are oriented to be parallel to the corresponding indexing surfaces of the other rail, and perpendicular to the lateral plane containing a longitudinal axis of each rail. The running surface 42 is located centrally between the upper and lower indexing surfaces to protrude inwardly relative to the common plane of the indexing surfaces.

Each rail 18 further include a top surface 54 which is sloped downwardly and outwardly from the top end of the upper indexing surface so that an apex at the intersection of the upper indexing surface and the top surface 54 forms an acute angle of less than 90°. Similarly, each rail 18 further includes a bottom surface 56 which is sloped upwardly and laterally outwardly from the bottom end of the lower indexing surface so that an apex at the intersection of the lower indexing surface and the bottom surface forms an acute angle of less than 90°.

Each of the rails 18 also includes three mounting channels 58 formed therein within the top surface 54, the bottom surface 56 and the outer side 60 of the rail respectively. Each mounting channel includes an outer slot which is open to the exterior surface of the channel and an inner slot which is enlarged in dimension relative to the outer slot so as to be generally T-shaped with the outer slot and so as to define two internal shoulders 60. The inner slot is thus suitably arranged to receive a nut 62 of a clamping fastener 64 which is described in further detail below. The nut is used for clamping various components to the rails by engaging the nut 62 against the internal shoulders 60 of the selected mounting channel 58.

Two fastener holes 66 are formed in the extruded profile of each rail at vertically spaced apart positions at a laterally central location. The holes enable threaded fasteners to be secured at opposing ends of the rail for fastening of the two end portions 22 of the frame across the outer ends of the rails to function as an end cap at both ends of the rails.

A plurality of crossmembers 68 are provided for connection between the two rails for indexing, straightening, and/or aligning the two rails relative to one another so that the running surfaces of the two rails are accurately positioned relative to one another to provide smooth rolling of the wheels of the carriage body. The crossmembers 68 are mounted at respective ones of a plurality of coupling locations at longitudinally spaced positions along the rails. More particularly, two crossmembers 68 are located at each one of two coupling locations adjacent longitudinally opposed ends of the rails. At each coupling location one crossmember 68 is mounted above the rails and one crossmember is mounted below the rails so that the crossmembers are diametrically opposed from one another.

Each crossmember 68 comprises a main beam 70 spanning in the lateral direction between the two rails at a location fully above or fully below the rails. Two locator flanges 72 are located in proximity to opposing ends of each main beam 70 to extend inwardly towards the diametrically opposed crossmember along the inner side of the rails 42 respectively. The laterally outward facing surface of each locator flange defines an indexing surface 74 for parallel abutment against a corresponding one of the upper or lower indexing surfaces of the respective rail.

A portion of the body of the crossmember 68 protruding laterally outwardly beyond the locator flange defines an auxiliary surface 76 along the inner side adjacent the respective indexing surface 74 which is sloped non-perpendicularly relative to the indexing surface to define an acute interior angle matching the angle of the apex between the upper indexing surface and the top surface, or the apex between the lower indexing surface and the bottom surface respectively. In this manner the auxiliary surface 76 is arranged for parallel abutment against a corresponding one of the top or bottom surfaces of the rail when the indexing surfaces of the crossmembers engage the corresponding indexing surfaces of the rails.

A fastener hole 78 extends vertically through the outer end portion of each crossmember to extend through the auxiliary surface 76 in alignment with a respective one of the mounting channels 58 in the top or bottom side of the respective rail. The fastener holes 78 receives a respective clamping fastener 64 therein such that the head of the faster engages an outer surface of the crossmember while the threaded shaft portion of the fastener is threaded into a respective nut 62 within the channel. The axis of the clamping fastener in this instance lies parallel to the indexing surface and perpendicular to the lateral plane containing the longitudinal axes of the two rails. In this manner the clamping fastener acts to provide a clamping force along the axis of the fastener between opposing surfaces of the crossmember and the rail respectively for urging either the top or bottom surface of the rail against a corresponding auxiliary surface 76 of the crossmember which is sloped towards the indexing surface. In this manner a single fastener at the connection of each clamping member to the rail provides clamping in the lateral direction between respective indexing surfaces for locating the rail relative to the crossmember in the lateral direction, while simultaneously engaging the clamping member with a corresponding top or bottom surface of the rail for aligning the crossmember relative to the rail along a Z-axis lying perpendicular to both the lateral direction and the longitudinal direction of the rails.

The two side portions 28 of the mounting plate 26 are similarly configured to the opposing ends of the crossmembers such that the side portions include corresponding locator flanges 72, indexing surfaces 74, auxiliary surfaces 76, and clamping fasteners 64 to align the two rails relative to one another at the location of the mounting plate 26 as well.

The camera slider assembly 10 further comprises a flywheel 80 supported on the frame at one end of the frame at one of the coupling locations where two crossmembers 68 are provided above and below the rails. An axle 82 supports the flywheel rotatably thereon in which the axle is mounted between the two crossmembers at a laterally centred location thereon so that the axle is perpendicular to the lateral plane of the rails. The flywheel comprises a generally cylindrical mass of conductive material, for example aluminum, having a diameter which closely matches the interior dimension between the running surfaces of the two rails while having a height in the axial direction which occupies most of the space between the two crossmembers, while being spaced below the upper crossmember. This allows space above the flywheel and below the upper crossmember for a drive assembly operatively connecting the carriage body to the flywheel to drive the rotation of the flywheel responsive to the longitudinal displacement of the carriage body along the rails.

The drive assembly includes a first pulley 84 supported on the same upper crossmember as the flywheel 80 at a location offset laterally to one side of the flywheel axle, and a second pulley 86 supported on the upper crossmember at the opposing end of the rails.

Each pulley 84 and 86 is supported on a respective post 88 threaded into the crossmember at a top end of the post. A pair of annular bearings 90 are supported along the post which are surrounded by a sleeve 92 rotatably carried on the post by the bearings. An upper end wall 94 extends radially inward from the top end of the sleeve to be captured between the bearings and the underside of the crossmember upon which the post 88 is supported. An annular bushing 96 is received between the bearings 90 and the crossmember to define an axial space which receives the end wall of the sleeve therein so that there is no friction between the rotation of the sleeve and the crossmember.

An annular flange 98 extends radially outward from the bottom end of the sleeve about the full circumference thereof having a groove located in the outer periphery thereof which receives a suitable drive belt 100 therein. The flywheel axle includes a reduced diameter portion 102 thereon at a location immediately above the flywheel body 84. The reduced diameter portion 102 lies in a generally common plane with the peripheral groove of the annular flanges 98 of both pulleys to define the plane receiving the drive belt therein. The drive belt comprises an elongate flexible belt coupled at both ends to respective ones of the longitudinally opposed ends of the carriage body. The intermediate portion of the belt is looped around both pulleys and the reduced diameter portion 102 of the flywheel axle such that the longitudinal displacement of the carriage body in two opposing directions is transmitted through the drive belt to a rotation of the pulleys and a rotation of the axle of the flywheel in two opposing directions of rotation.

A brake member 104 is also supported on the same upper crossmember that supports the flywheel 80 thereon to provide the function of an eddy current brake. The brake member includes a threaded post 106 which is threaded into the crossmember at the top end thereof at a location which is offset laterally from the flywheel axle in the opposing direction relative to the first pulley shaft. The brake member includes a screw body 108 which is threaded onto the post 106 such that rotation of the brake member about the axis of the screw displaces the screw body axially to vary the distance of the brake member body 108 from the flywheel. The axis of the post 106 is parallel to the axis of rotation of the flywheel. A permanent magnet 110 is mounted into the bottom end of the screw body at the inner side closest to the flywheel.

The permanent magnet will induce circular electrical currents called eddy currents in the conductive material of the flywheel. The circulating currents will create their own magnetic field which opposes the field of the magnet such that the moving flywheel body will experience a drag force from the magnet that opposes its motion, proportional to its velocity. The electrical energy of the eddy currents is dissipated as heat due to the electrical resistance of the conductive material. The magnet is positionable relative to the flywheel in a non-breaking position in which the drag force is negligible so as to have no noticeable effect on the movement of the carriage when the brake member screw body 108 is positioned closest to the crossmember and farthest from the flywheel. Varying the distance of the magnet from the flywheel will vary the drag force opposing the rotation of the flywheel.

In use, the camera slider assembly 10 can be positioned on a variety of supporting surfaces using the adjustable legs 25 at opposing ends of the frame 16. Instead, the legs can also be pivoted out of use so that each of the lower crossmembers and the mounting plate 26 can be directly supported on a supporting surface using respective feet 30. Each of the feet 30 is supported on a threaded post which is threaded into the crossmember or the mounting plate 26 so that the two feet 30 of the side portions of the frame and the four feet of the lower crossmembers of the frame can thus all be adjusted such that the bottom sides thereof are aligned within a common plane such that all of the feet can engage a common plane or supporting surface and provide support to the rails without any deflection of the rails.

A user supports a camera on the carriage body using any available mounting means so that the camera is movable together with the carriage body along the rails. The two rails are assembled relative to one another using the crossmembers described above to accurately locate the running surfaces of the rails relative to one another to ensure a smooth movement of the carriage body along the rails with very tight tolerances therebetween. The drive assembly using the drive belt 100 ensures that any longitudinal displacement of the carriage body will result in rotation of the flywheel. The amount of drag imposed against the rotation of the flywheel is readily adjusted using the eddy current brake member 104 described above according to the user's preference.

In some instances, it is desirable to limit the movement of the carriage body over a limited range of the overall length of the rails. In this instance, a bumper 112 or a stop 114 may be used by fastening at a selected location along one of the rails. The bumper or stop is fastened to a respective one of the channels 58 at the top side or outer side of the rail respectively. In each instance, the bumper or the stop comprises a lug of material having a fastener hole therein for receiving a clamping fastener 64 that can be threaded into a nut 62 received within the mounting channel 58 for clamping the lug of material to the rail similarly to the clamping of the crossmembers to the rails.

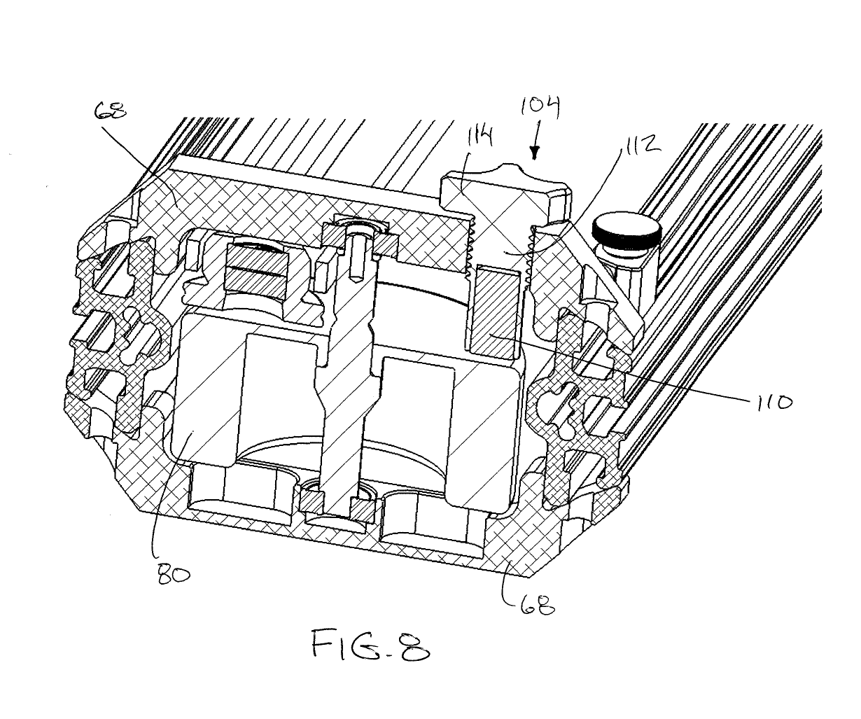

Turning now to the second embodiment of the camera slider assembly shown in FIG. 8, the camera slider assembly 10 in this instance is substantially identical to the previous embodiment with the exception of the configuration of the brake member 104. The brake member 104 remains supported on the same upper crossmember 68 that supports the flywheel 80 thereon so as to provide the function of an eddy current brake; however, the manner of adjusting the proximity of the permanent magnet 110 relative to the flywheel has been modified. As shown in FIG. 8, a screw body 112 is provided in the form of a threaded shaft which is mounted to extend fully through a mating threaded bore within the crossmember 68. A bottom or inner end of the screw body nearest to the flywheel 80 includes a cavity therein within which the magnet 110 is fixedly mounted. As the screw body is rotated, the entire screw body is displaced in the axial direction of the shaft by the mating interaction of the threads on the screw body with the threads within the bore in the crossmember 68 so as to displace the magnet towards or away from the flywheel 80. The opposing outer end of the screw body 112 which is above and external of the crossmember 68 is enlarged in cross-sectional diameter relative to the threaded shaft portion to form a knob 114 suitable for gripping in the fingers of the user to provide the input rotation for rotating the screw body about its longitudinal axis. In the usual manner of a screw, rotating in one direction will longitudinally displace the screw body in one direction, whereas rotating the screw body in the opposing direction will longitudinally displace the screw body in the opposing direction.

Various modifications can be made in my invention as herein above described, and many apparently widely different embodiments of same made. It is intended that all matter contained in the accompanying specification shall be interpreted as illustrative only and not in a limiting sense.

1. A camera slider assembly for supporting a camera thereon, the assembly comprising:
a frame including at least one rail extending in a longitudinal direction;
a carriage body supported on said at least one rail for longitudinal movement along the rail in the longitudinal direction;
a camera mount supported on the carriage body for supporting the camera thereon for movement with the carriage body in the longitudinal direction relative to the frame;
a flywheel supported on the frame and rotatable relative to the frame about a flywheel axis, the flywheel being formed of a conductive material;
a drive system operatively connected between the carriage body and the flywheel so as to drive rotation of the flywheel responsive to the longitudinal movement of the carriage body relative to the frame in the longitudinal direction; and
a magnet supported on the frame and positionable in proximity to the flywheel so as to induce an eddy current the conductive material of the flywheel imposing a drag force from the magnet opposing the motion of the flywheel;
the magnet being movable in distance relative to the flywheel so as to vary the drag force.

2. The camera slider assembly according to claim 1 wherein the magnet is movable to a non-braking position in which the drag force is negligible.

3. The camera slider assembly according to claim 1 wherein the flywheel is rotatably supported at a fixed location on the frame and the magnet is movable relative to the fixed location of the flywheel on the frame.

4. The camera slider assembly according to claim 1 wherein the magnet is movable relative to the flywheel along an adjustment axis oriented parallel to the flywheel axis.

5. The camera slider assembly according to claim 1 further comprising a screw along the adjustment axis which supports the magnet on the frame such that rotation of the screw about the adjustment axis displaces the magnet relative to the flywheel along the adjustment axis.

6. The camera slider assembly according to claim 1 wherein the frame comprises two rails and a plurality of cross members connected between the two rails to support the rails parallel and spaced apart from one another, the flywheel and the magnet being supported on one of the cross members.

7. A camera slider assembly for supporting a camera thereon, the assembly comprising:
a frame comprising two rails supported parallel and spaced apart from one another to extend in a longitudinal direction of the frame and a cross member connected between the two rails at each one of a plurality of coupling locations at longitudinally spaced positions along the rails;
a carriage body supported on the frame and being movable along the two rails in the longitudinal direction;
a camera mount supported on the carriage body and adapted to support the camera thereon for movement with the carriage body in the longitudinal direction relative to the frame;
each cross member comprising:
two indexing surfaces oriented transversely to a lateral plane containing the two rails in parallel abutment with corresponding indexing surfaces on the two rails respectively;
two auxiliary surfaces adjacent to and oriented transversely to the two indexing surfaces on the cross member respectively in abutment with corresponding auxiliary surfaces on the two rails; and
two clamping fasteners operatively connected between the cross member and each of the rails respectively, such that each clamping fastener is arranged to urge both a respective one of the indexing surfaces of the cross member and a respective one of the auxiliary surfaces of the cross member against the corresponding indexing surface and auxiliary surface of the respective rail.

8. The camera slider assembly according to claim 7 wherein the indexing surfaces of the two rails are oriented parallel to one another and perpendicularly to the lateral plane containing the two rails.

9. The camera slider assembly according to claim 7 wherein each rail comprises a channel extending longitudinally along the rail so as to define an internal shoulder within the channel, each clamping fastener being operatively connected to provide a clamping force between the internal shoulder of the respective rail and an opposing surface on the respective cross member.

10. The camera slider assembly according to claim 7 wherein the frame comprises two cross members at each coupling location which are coupled to each rail at diametrically opposed top and bottom sides of the rail.

11. The camera slider assembly according to claim 10 further comprising:
the indexing surfaces of each rail comprise an upper indexing surface engaged by one of the cross members at a top side of the rail and a lower indexing surface engaged by one of the cross members at a bottom side of the rail;
the upper and lower indexing surfaces lying in a common plane at an inner side of the rail facing inwardly towards the other rail; and
a running surface at an inner side of each rail between the upper and lower indexing surfaces upon which the carriage body is supported for movement along the rails.

12. The camera slider assembly according to claim 7 wherein each auxiliary surface of each cross member is oriented non-perpendicularly at an acute interior angle relative to the respective indexing surface.

13. The camera slider assembly according to claim 7 wherein the auxiliary surfaces on the rails are oriented in parallel abutment with respective ones of the auxiliary surfaces on the cross members.

14. The camera slider assembly according to claim 12 wherein each clamping fastener is oriented parallel to the indexing surfaces.

15. The camera slider assembly according to claim 7 wherein the clamping fasteners are the only fasteners securing each cross member to the rails and wherein the clamping fasteners are all oriented perpendicularly to the lateral plane containing the two rails.

16. The camera slider assembly according to claim 7 further comprising:
a flywheel supported on the frame and rotatable relative to the frame about a flywheel axis, the flywheel being formed of a conductive material;
a drive system operatively connected between the carriage body and the flywheel so as to drive rotation of the flywheel responsive to the longitudinal movement of the carriage body relative to the frame in the longitudinal direction; and
a magnet supported on the frame and positionable in proximity to the flywheel so as to induce an eddy current the conductive material of the flywheel imposing a drag force from the magnet opposing the motion of the flywheel;
the magnet being movable in distance relative to the flywheel so as to vary the drag force.

17. The camera slider assembly according to claim 16 wherein the magnet movable to a non-braking position in which the drag force is negligible.

18. The camera slider assembly according to claim 16 wherein the magnet is movable relative to the flywheel along an adjustment axis oriented parallel to the flywheel axis.

19. The camera slider assembly according to claim 16 further comprising a screw along the adjustment axis which supports the magnet on the frame such that rotation of the screw about the adjustment axis displaces the magnet relative to the flywheel along the adjustment axis.

20. The camera slider assembly according to claim 16 wherein the flywheel and the magnet are supported on one of the cross members.
